(19) United States
(12) Patent Application Publication
(10) Pub. No.: US 2026/0158515 A1
(43) Pub. Date: Jun. 11, 2026

(54) COATING-MACHINE CLEANING HOPPER

(71) Applicant: TRINITY INDUSTRIAL CORPORATION, Aichi (JP)

(72) Inventors: Makoto SHIMIZU, Aichi (JP); Kazunori HAGIWARA, Aichi (JP); Naoki YAMATO, Aichi (JP); Hisaki ABE, Aichi (JP)

(21) Appl. No.: 18/850,595

(22) PCT Filed: Mar. 28, 2022
(86) PCT No.: PCT/JP2022/015227

§ 371 Date: Sep. 25, 2024

(51) Int. Cl. B05B 15/555

(52) U.S. Cl. CPC B05B 15/555

(57) ABSTRACT

A coating-machine cleaning hopper includes a cylindrical body with an opening at its upper end and an upper lid that covers the opening. The upper lid has an insertion hole through which a rotating atomizing head, rotatably provided on the coating machine, can be inserted into the cylindrical body. The hopper includes a tank-shaped member provided outside the cylindrical body. The tank-shaped member includes a cylindrical outer wall section with exhaust holes formed in its upper part and a bottom section with a concavely curved inner surface. A baffle plate, which restricts upward movement of waste paint discharged from the rotating atomizing head, is provided, protruding around the entire circumference of the lower inner surface of the outer wall section. The coating-machine cleaning hopper can reliably separate air from other components in the waste paint, preventing the leakage of waste liquid to the outside, and discharging only the air.

### TECHNICAL FIELD

This invention relates to a coating-machine cleaning hopper used for cleaning the rotating atomizing head of a coating machine.

### TECHNICAL BACKGROUND

In general, coating robots are mainly used for coating objects, such as automobile bodies.

The coating robot is installed in a painting booth and is equipped with an arm that bends and rotates during the painting process, as well as a painting machine mounted at the end of the arm. The coating machine is equipped with a bell-shaped rotating atomizing head and other equipment. In addition to painting the coated object, the coating robot also sprays excess paint (waste paint) into a waste paint collection container during color changes.

A coating-machine cleaning hopper 151 shown in FIG. 5 has been conventionally proposed as an example of such a waste paint collection container. This coating-machine cleaning hopper 151 comprises a hopper body 153, which is a cylindrical body with an opening 152 at its upper end, and an upper lid 154 that covers the opening 152. The upper lid 154 is provided with an insertion hole 155. Through the insertion hole 155, a rotating atomizing head 156 is inserted into the hopper body 153, and in this state, while discharging the waste paint, cleaning liquid is sprayed for cleaning. As a result, the waste paint and the cleaning liquid are collected inside the hopper 151 as waste liquid. A similar type of coating-machine cleaning hopper is also disclosed in Patent Documents 1 and 2, for example.

### PRIOR ART DOCUMENTS

### Patent Documents

Patent Document 1: Japanese Published Unexamined Patent Application No. 2006-334574

Patent Document 2: Japanese Published Unexamined Patent Application No. 2009-34635

### DISCLOSURE OF THE INVENTION

### Problem to Be Solved by the Invention

The conventional coating-machine cleaning hopper 151 described above is an open-type hopper with an air vent opening 157 formed at the lower end of the hopper body 153. As a result, structurally, waste liquid leaks to the outside through the opening 157, and the waste liquid recovery rate was approximately 70%. In FIG. 5, the flow of recoverable waste liquid is indicated by dashed arrow A1, while the flow of unrecoverable waste liquid is indicated by dashed arrow A2.

Recently, dry-type coating booths that do not use water are becoming the mainstream. In other words, it is now required to eliminate waste liquid leakage outside the hopper and reduce unrecovered waste liquid to zero. Accordingly, the present inventors have been considering a sealed-type hopper structure, in which the lower end of the hopper body is provided with a bottom and the opening is eliminated. However, it has been found that simply closing the opening at the lower end and providing a bottom does not ensure complete separation of the air component in the waste paint from the other components (paint particles and liquid), and thus, waste liquid leakage to the outside cannot be prevented. Furthermore, it has also been found that the waste paint discharged from the rotating atomizing head 156 tends to splash back toward the insertion hole 155, causing additional problems.

The present invention has been made in view of the above issues, and its objective is to provide a coating-machine cleaning hopper that can reliably separate the air component from the other components in the waste paint, prevent waste liquid from leaking to the outside, and discharge only the air component.

### Means for Solving the Problem

To solve the above problems, the first aspect of the present invention refers to a coating machine cleaning hopper, comprising: a cylindrical body having an opening at an upper end and a cleaning space inside; and an upper lid covering the opening, the upper lid having an insertion hole through which a rotating atomizing head, rotatably provided on the coating machine, can be inserted into the cylindrical body; wherein a tank-shaped member is provided outside the cylindrical body, the tank-shaped member including a cylindrical outer wall section with exhaust holes formed in an upper portion, and a bottom section with a concavely curved inner surface; and a baffle plate provided, protruding around the entire circumference of the lower inner surface of the outer wall section, restricting the upward movement of waste paint discharged from the rotating atomizing head.

Therefore, according to the first aspect of the present invention, the tank-shaped member has a bottom at its lower end and no opening, preventing waste liquid from leaking directly to the outside from the lower end. When waste paint is discharged from the rotating atomizing head, it hits the concave curved bottom and is smoothly guided along its inner surface from the outer edge of the bottom to the lower part of the outer wall section. It then tries to move upward along the inner surface of the outer wall. However, a baffle plate is provided protruding from the lower inner surface of the outer wall section to restrict the upward movement of the waste paint. This baffle plate ensures that the air component in the waste paint is reliably separated from the other components. As a result, only the air component moves upward, passes over the baffle plate, and is discharged to the outside through the exhaust hole formed at the top of the outer wall section. On the other hand, the non-air components (i.e., the waste liquid) cannot pass over the baffle plate and remain in the bottom. Therefore, waste liquid leakage to the outside is prevented, and only the air component is discharged. In other words, the unrecovered waste liquid rate can be reduced to zero.

The second aspect of the present invention refers to the coating-machine cleaning hopper according to the first aspect, wherein a restriction wall is provided protruding from the rear opening edge of the insertion hole in the upper lid, extending toward the bottom, to restrict the flow of waste paint from the cylindrical body side toward the insertion hole side.

When the waste paint discharged from the rotating atomizing head hits the bottom and bounces back, there is a risk that the waste paint will return toward the insertion hole and contaminate the rotating atomizing head. In this regard, according to the invention described in the second aspect, the flow of waste paint from the cylindrical body side toward the insertion hole side is restricted by the restriction wall. Therefore, the non-air components of the waste paint cannot reach the insertion hole side, making it less likely for the rotating atomizing head to become contaminated.

The third aspect of the present invention refers to the coating-machine cleaning hopper according to the second aspect, wherein the lower end of the cylindrical body is positioned below the height of the baffle plate, and a gap is provided between the cylindrical body and the baffle plate.

Therefore, according to the third aspect of the present invention, since the lower end of the cylindrical body is positioned below the height of the baffle plate, the waste paint does not directly reach the upper part of the outer wall section, making it less likely for the waste liquid to be discharged through the exhaust hole. Thus, the efficiency of waste liquid recovery is reliably improved. Additionally, with this configuration, the baffle plate is positioned in the space formed between the outer wall section and the cylindrical body, and a gap narrower than the surrounding space is formed between the cylindrical body and the baffle plate. As a result, it becomes even more difficult for the non-air components of the waste paint to pass over the baffle plate and move upward, allowing only the air component to move upward.

The fourth aspect of the present invention refers to the coating-machine cleaning hopper according to the second or the third aspect, wherein the amount of downward protrusion of the restriction wall, based on the rear surface of the upper lid, is smaller than the amount of downward protrusion of the cylindrical body, based on the rear surface of the upper lid.

If the restriction wall located near the rotating atomizing head has a large amount of downward protrusion, there is a risk that the waste paint discharged from the rotating atomizing head will directly hit it with force, causing splashing and potentially contaminating the rotating atomizing head. In this regard, according to the fourth aspect of the present invention, since the amount of downward protrusion of the restriction wall is smaller than that of the cylindrical body, the waste paint discharged from the rotating atomizing head is less likely to directly hit the restriction wall. As a result, splashing of the waste paint is avoided, and the rotating atomizing head is less likely to become contaminated.

The fifth aspect of the present invention refers to the coating-machine cleaning hopper according to any one of the first to fourth aspects, comprising a first part including the upper lid, a second part including the upper cylindrical member forming the cylindrical body, a third part including the lower cylindrical member connected to the lower end of the upper cylindrical member and forming part of the cylindrical body, and a fourth part including the tank-shaped member that has the outer wall section, the bottom section, and the baffle plate, with each of these parts being able to be disassembled and assembled together.

The sixth aspect of the present invention refers to the coating-machine cleaning hopper according to the fifth aspect, further comprising a fifth part including a filter member disposed in the liquid discharge passage provided at the central part of the bottom, with each of these parts being able to be disassembled and assembled together.

Therefore, according to the fifth and sixth aspects of the present invention, since the components of the coating-machine cleaning hopper can be disassembled into multiple parts, each component can be easily cleaned, improving maintenance efficiency.

The seventh aspect of the present invention refers to the coating-machine cleaning hopper according to the sixth aspect, wherein the upper lid of the first part and the upper flange of the second part are arranged overlapping each other and fastened together with screws, and the lower flange of the second part, the flange of the third part, and the flange of the fourth part are arranged overlapping each other and fastened together with screws.

Therefore, according to the seventh aspect of the present invention, by loosening and removing the screws that fasten the upper lid and the upper flange of the second part, the first part and the second part can be easily separated. Additionally, by loosening and removing the screws that fasten the lower flange of the second part, the flange of the third part, and the flange of the fourth part, the second, third, and fourth parts can be easily separated.

### Effect of the Invention

As described in detail above, according to the first to the seventh aspects of the present invention, it is possible to provide a coating-machine cleaning hopper that reliably separates the air component from the other components in the waste paint, prevents waste liquid from leaking to the outside, and discharges only the air component.

### BRIEF DESCRIPTION OF THE DRAWINGS

FIG. 1 is a schematic view illustrating the usage state of the coating-machine cleaning hopper according to the first embodiment of the present invention.

FIG. 2 is a schematic cross-sectional view showing the coating-machine cleaning hopper according to the first embodiment.

FIG. 3 is a schematic cross-sectional view showing the coating-machine cleaning hopper according to the second embodiment.

FIG. 4 is a schematic cross-sectional view showing the disassembled state of the coating-machine cleaning hopper according to the second embodiment.

FIG. 5 is a schematic cross-sectional view showing a conventional coating-machine cleaning hopper.

### MODES FOR CARRYING OUT THE INVENTION

### First Embodiment

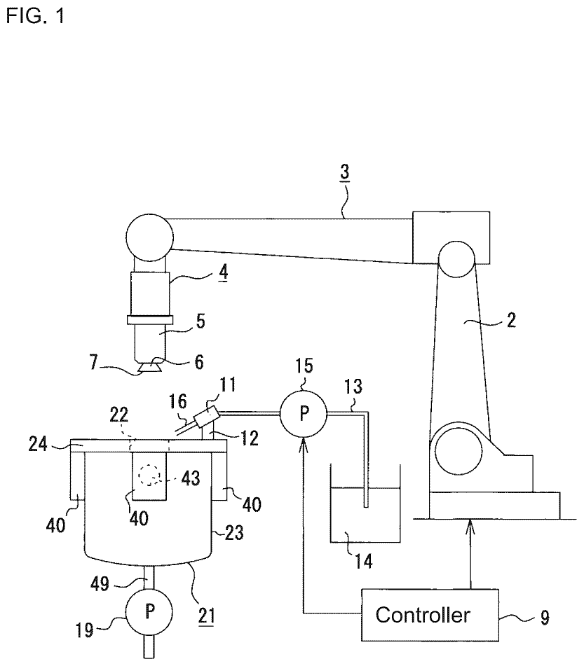

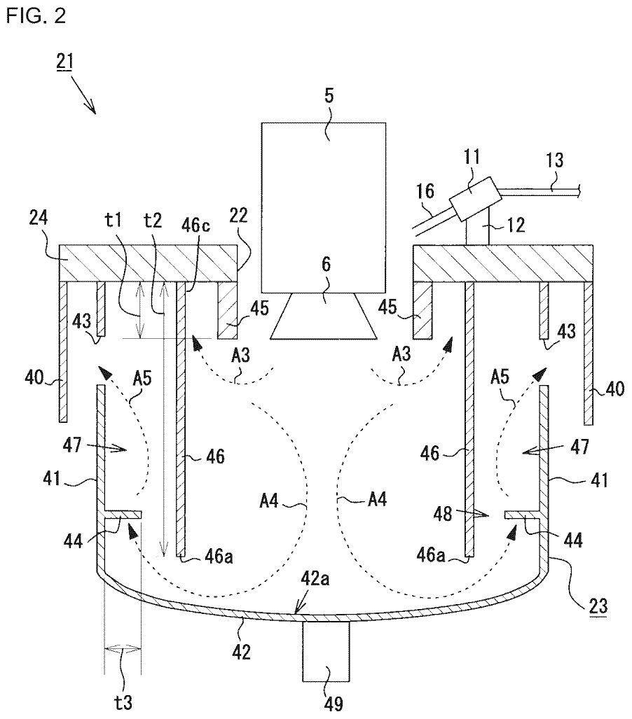

Hereinafter, a sealed-type coating-machine cleaning hopper 21, which is one embodiment of the present invention, will be described in detail with reference to FIGS. 1 and 2.

As shown in FIG. 1, the coating-machine cleaning hopper 21 of this embodiment forms part of the cleaning mechanism for cleaning the coating machine 4 attached to the coating robot 3. The coating robot 3 is a multi-jointed robot used for painting objects to be coated (not shown), such as automobile bodies. The coating robot 3 is equipped with an arm 2 that bends and rotates when painting objects to be coated, and the coating machine 4 is attached to the tip of the arm 2. The coating machine 4 changes its height and paint spraying direction according to the bending and rotation of the arm 2. The arm 2 is equipped with multiple motors (not shown) for moving the joints, and these motors are driven and controlled based on control signals from the controller 9.

The coating machine 4 includes a substantially cylindrical coating machine body 5 and a bell-shaped rotating atomizing head 6. The coating machine body 5 is equipped with a paint container (not shown) that stores paint and a paint supply mechanism (not shown) that supplies paint from the paint container to the rotating atomizing head 6. The rotating atomizing head 6 is attached to the coating machine body 5 and is designed to rotate by a motor provided in the coating machine body 5 for rotating the atomizing head. When the rotating atomizing head 6 rotates, the paint supplied by the paint supply mechanism is dispersed toward the outer periphery by centrifugal force and atomized. Both the paint supply mechanism and the atomizing head rotation motor are driven and controlled based on control signals from the controller 9. The front portion 7 of the rotating atomizing head 6 has a tapered surface that increases in diameter toward the front end.

As shown in FIG. 1, the coating-machine cleaning hopper 21 is provided separately from the coating machine 4 and is positioned near the coating robot 3. The coating-machine cleaning hopper 21 has the function of collecting cleaning liquid, such as water, and the function of collecting waste paint discharged from the coating machine 4 during color changes. As shown in FIG. 2, the coating-machine cleaning hopper 21 includes a substantially cylindrical body 46 with an opening 46c at the upper end and a cleaning space inside, as well as an approximately circular upper lid 24 that covers the opening 46c. The material forming the cylindrical body 46 and the upper lid 24 is not limited, but both are made of stainless steel in this embodiment.

Meanwhile, the upper lid 24 is attached to the cylindrical body 46 so as to cover the opening 46c. Specifically, bolts (not shown) are inserted through the outer edge of the upper lid 24 and the rim of the cylindrical body 46, and nuts (not shown) are fastened to the ends of the bolts, securing the upper lid 24 to the cylindrical body 46. In other words, the upper lid 24 in this embodiment is detachably attached to the cylindrical body 46. Additionally, at the center of the upper lid 24, an insertion hole 22 is provided, through which the rotating atomizing head 6 can be inserted into the cylindrical body 46. The insertion hole 22 is circular, and its inner diameter is set so that there is a gap of between 10 mm and 50 mm between the inserted rotating atomizing head 6 and the edge of the hole. In this embodiment, the inner diameter is set to 120 mm.

A nozzle 11 for spraying cleaning liquid is fixed to the upper surface of the upper lid 24 via a mounting bracket 12 or the like. The nozzle 11 is positioned near the edge of the opening of the insertion hole 22, outside the coating-machine cleaning hopper 21. As shown in FIG. 1, the nozzle 11 is installed at the end of a cleaning liquid supply line 13 that supplies cleaning liquid. Additionally, a cleaning liquid container 14, which stores the cleaning liquid, and a pump 15, which pumps the cleaning liquid from the cleaning liquid container 14 to the nozzle 11, are provided on the cleaning liquid supply line 13. The pump 15 is driven based on control signals from the controller 9, causing the nozzle 11 to spray the cleaning liquid. The nozzle 11 is equipped with two cleaning liquid spray pipes 16 extending in the same direction. Each cleaning liquid spray pipe 16 is arranged in a downward diagonal direction, with its tip aimed at the rear surface of the rotating atomizing head 6.

As shown in FIG. 2, the tank-shaped member 23 that constitutes the coating-machine cleaning hopper 21 includes a substantially cylindrical outer wall section 41 and a bottom section 42 that closes the lower end of the outer wall section 41. The tank-shaped member 23 is arranged to enclose the outside of the cylindrical body 46. The dimensions of the outer wall section 41 are not particularly limited, but for example, the inner diameter is set to about 300 mm, and the height (axial dimension) is set to about 200 mm to 400 mm. In multiple locations in the upper region of the outer wall section 41 (in this embodiment, for example, four locations), exhaust holes 43 are formed to allow communication between the inside and outside of the outer wall section 41 and to exhaust air. In multiple locations on the outer side of the outer wall section 41, duct-shaped cover members 40 are provided over each exhaust hole 43, thereby forming exhaust ports.

The entire inner surface 42a of the bottom section 42 is gently curved in a concave shape. The outer peripheral part of the inner surface 42a of the bottom section 42 is connected to the lowest part of the inner circumferential surface of the vertically extending outer wall section 41. As a result, a guide surface is formed that smoothly guides the discharged waste paint from the bottom section 42 to the vertically extending outer wall section 41. Additionally, at the lowest point of the bottom section 42, in the center, a liquid discharge passage 49 is provided to discharge the accumulated waste liquid from inside the coating-machine cleaning hopper 21 to the outside. A pump 19 is installed along the path of this liquid discharge passage 49.

A baffle plate 44 is provided, protruding around the entire circumference of the lower inner surface of the outer wall section 41. The baffle plate 44 serves as a barrier to restrict the upward movement of waste paint discharged from the rotating atomizing head 30. The amount of protrusion t3 of the baffle plate 44 from the inner surface of the outer wall section 41 is not particularly limited as long as it can effectively restrict the upward movement of the waste paint. In this embodiment, it is set to about 5 mm to 20 mm.

On the rear opening edge of the insertion hole 22 in the upper lid 24, a restriction wall 45 is provided, extending toward the bottom section 42. The restriction wall 45 serves to restrict the flow of waste paint from the cylindrical body 46 side toward the insertion hole 22. The amount of downward protrusion t1 of the restriction wall 45 from the rear side of the upper lid 24 is not particularly limited and can be set arbitrarily, but in this embodiment, it is set to about 10 mm to 30 mm. Additionally, the amount of protrusion t1 of the restriction wall 45 is set to be smaller than the amount of downward protrusion t2 of the cylindrical body 46, which will be described later.

The cylindrical body 46 is positioned between the outer wall section 41 and the restriction wall 45. It can also be understood that the cylindrical body 46 protrudes downward from the rear surface of the upper lid 24 toward the bottom section 42. A space 47 is formed between the outer wall section 41 and the cylindrical body 46 to guide only the air component in the waste paint upward. The cylindrical body 46 has a length approximately equal to that of the outer wall section 41, so the lower end 46a of the cylindrical body 46 reaches near the inner surface 42a of the bottom section 42. The lower end 46a of the cylindrical body 46 is positioned almost at the same height as the lowest part of the outer wall section 41. It is preferable that a gap of about 10 mm to 50 mm is formed between the lower end 46 a of the cylindrical body 46 and the inner surface 42a of the bottom section 42, and in this embodiment, a gap of about 30 mm is formed.

The baffle plate 44 is positioned several tens of millimeters above the lowest part of the outer wall section 41. Therefore, the lower end 46a of the cylindrical body 46 is positioned below the height of the baffle plate 44. Additionally, a gap 48 is provided between the cylindrical body 46 and the baffle plate 44.

Next, the cleaning operation of the coating-machine cleaning hopper 21 in this embodiment will be described.

First, when the painting of an object to be coated by the coating machine 4 is completed and it becomes necessary to change colors for painting the next object, the controller 9 drives the arm 2 to move the coating machine 4 horizontally along the movement path. When the coating machine 4 reaches the position above the insertion hole 22, the controller 9 drives the arm 2 to lower the coating machine 4. This operation inserts the rotating atomizing head 6 into the coating-machine cleaning hopper 21 through the insertion hole 22. Then, by driving the coating machine 4 to spray paint, the controller 9 causes the excess paint inside the coating machine 4 to be discharged as waste paint into the coating-machine cleaning hopper 21.

Next, the controller 9 drives the atomizing head rotation motor to rotate the rotating atomizing head 6 at, for example, 15,000 rpm. In this state, the controller 9 drives the pump 15 to supply cleaning liquid to the nozzle 11, and the cleaning liquid is sprayed from each cleaning liquid spray pipe 16 toward the rear surface of the rotating atomizing head 6. As a result, the paint remaining on the rear surface of the rotating atomizing head 6 is removed by the cleaning liquid. For example, the cleaning liquid is sprayed for a predetermined time (in this embodiment, slightly less than 1 second).

After the cleaning liquid spraying is completed, the controller 9 stops driving the atomizing head rotation motor, but the rotating atomizing head 6 continues to rotate for a certain period due to inertial force. As a result, the cleaning liquid and waste paint adhering to the rotating atomizing head 6 are scattered toward the outer periphery by centrifugal force, and the rotating atomizing head 6 dries. Therefore, when painting the next object, it is possible to prevent the cleaning liquid or waste paint from falling from the rotating atomizing head 6 onto the object, which could prevent a decrease in the coating quality of the object.

After the cleaning operation is completed, the next color paint is filled into the paint container in the coating machine body 5, and the color change is performed. Then, the controller 9 drives the arm 2 to raise the coating machine 4, moving the rotating atomizing head 6 out of the coating-machine cleaning hopper 21. Furthermore, the controller 9 drives the arm 2 to move the coating machine 4 to the starting position for the coating operation. Subsequently, the controller 9 drives the coating machine 4 to begin coating the next object

Therefore, according to this embodiment configured as described above, the following advantages can be obtained.

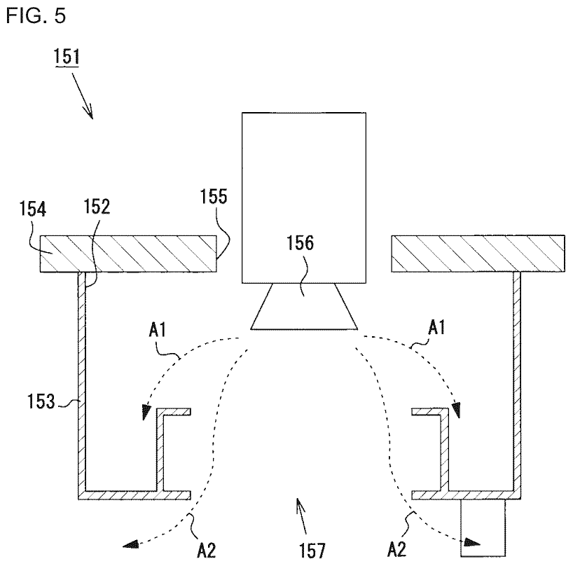

(1) In the sealed-type coating-machine cleaning hopper 21 of this embodiment, the tank-shaped member 23 has a bottom section 42 at its lower end and does not have an opening. Therefore, unlike the conventional open-type coating-machine cleaning hopper 151 shown in FIG. 5, waste liquid does not directly leak out from the lower end.

(2) The sealed-type coating-machine cleaning hopper 21 of this embodiment is provided with a tank-shaped member 23, which has an outer wall section 41 with exhaust holes 43 formed in the upper part, and a bottom section 42 with a concavely curved inner surface 42a. Additionally, a baffle plate 44 is provided, protruding around the entire circumference of the lower inner surface of the outer wall section 41 to restrict the upward movement of the waste paint discharged from the rotating atomizing head 6. When waste paint is discharged from the rotating atomizing head 6, it hits the concavely curved bottom section 42 and is smoothly guided along its inner surface 42a from the outer edge of the bottom to the lower part of the outer wall section 41. The waste paint then attempts to move upward along the inner surface of the outer wall section 41 (see dashed-line arrow A4 in FIG. 2). However, due to the function of the baffle plate 44, which is provided protruding from the lower inner surface of the outer wall section 41, the upward movement of the waste paint is restricted, and the air component is reliably separated from the other components of the waste paint. As a result, only the air, which does not contain liquid or paint particles, passes over the baffle plate 44 and moves upward through the space 47, eventually being exhausted to the outside through the exhaust holes 43 formed in the upper part of the outer wall section 41 (see dashed arrow A5 in FIG. 2). Meanwhile, the waste liquid containing liquid and paint particles cannot pass over the baffle plate 44 and remains in the bottom section 42. This ensures that waste liquid does not leak to the outside, allowing only the air to be discharged. In other words, the unrecovered waste liquid rate can be reduced to zero. Therefore, it is possible to provide a coating-machine cleaning hopper 21 that fully meets the increasing demand for a dry process without using water, which is becoming more common in recent times.

(3) In the sealed-type coating-machine cleaning hopper 21 of this embodiment, a restriction wall 45 is provided, protruding from the rear opening edge of the insertion hole 22 in the upper lid 24, extending downward toward the bottom section 42. For example, waste paint discharged from the rotating atomizing head 6 may bounce off the bottom section 42 or the cylindrical body 46 (see dashed-line arrow A3 in FIG. 2). In such cases, there is a risk that the waste paint could return to the insertion hole 22 side and contaminate the rotating atomizing head 6. However, in this embodiment, the flow of waste paint from the cylindrical body 46 side toward the insertion hole 22 side is restricted by the restriction wall 45. As a result, components other than the air in the waste paint cannot reach the insertion hole 22 side, making it less likely for the rotating atomizing head 6 to become contaminated. Therefore, the frequency of cleaning the rotating atomizing head 6 can be reduced.

(4) In the sealed-type coating-machine cleaning hopper 21 of this embodiment, it can be understood that a cylindrical body 46 is provided, protruding between the outer wall section 41 and the restriction wall 45 on the rear side of the upper lid 24. By positioning the cylindrical body 46 in this manner, the flow path of the waste paint from the rotating atomizing head 6 toward the exhaust hole 43 is blocked midway. As a result, the waste paint discharged from the rotating atomizing head 6 does not directly reach the upper part of the outer wall section 41, making it less likely for the waste liquid to be discharged from the exhaust hole 43. Therefore, the efficiency of recovering the waste liquid is significantly improved.

(5) In the sealed-type coating-machine cleaning hopper 21 of this embodiment, the lower end 46a of the cylindrical body 46 is positioned below the height of the baffle plate 44. Thus, the waste paint does not directly reach the upper part of the outer wall section 41, making it less likely for the waste liquid to be discharged from the exhaust hole 34. Therefore, the efficiency of recovering the waste liquid is significantly improved. In this configuration, the baffle plate 44 is positioned within a space 47 formed between the outer wall section 41 and the cylindrical body 46, and a narrower gap 48 than the space 47 is formed between the cylindrical body 46 and the baffle plate 44. Consequently, it becomes even more difficult for components other than the air in the waste paint to move upward beyond the baffle plate 44, allowing only the air to move upward. In other words, the air in the waste paint can be separated more reliably from the other components.

(6) In the sealed-type coating-machine cleaning hopper 21 of this embodiment, the amount of downward protrusion t1 of the restriction wall 45, based on the rear surface of the upper lid 24, is smaller than the amount of downward protrusion t2 of the cylindrical body 46, also based on the rear surface of the upper lid 24. If the restriction wall 45 were positioned closer to the rotating atomizing head 6 and had a larger downward protrusion t1, there would be a risk that the waste paint discharged from the rotating atomizing head 6 could hit the restriction wall 45 with force and bounce back, making the rotating atomizing head 6 more prone to contamination. However, with the configuration of this embodiment, the waste paint discharged from the rotating atomizing head 6 is less likely to directly hit the restriction wall 45. As a result, the risk of paint splashing back is reduced, and the rotating atomizing head 6 is less likely to become contaminated.

### Second Embodiment

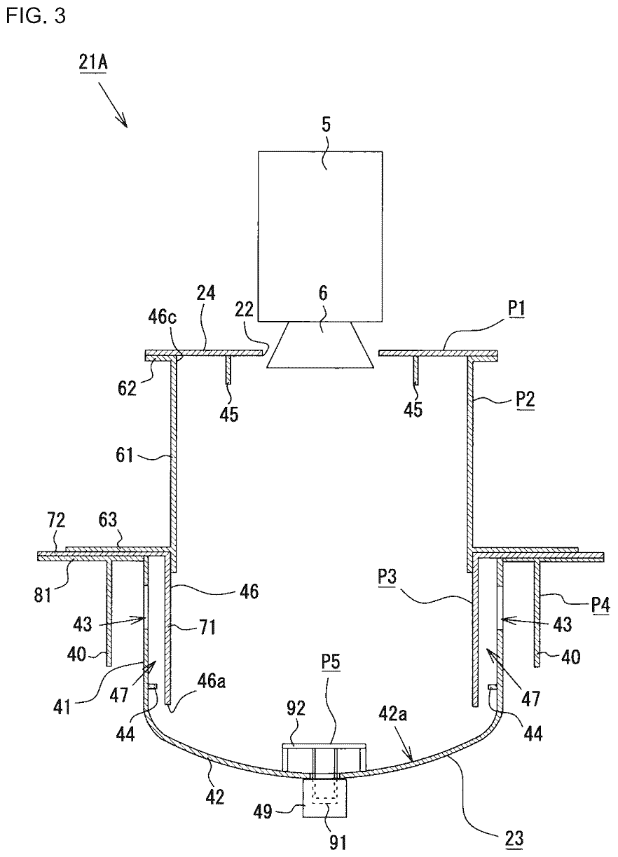

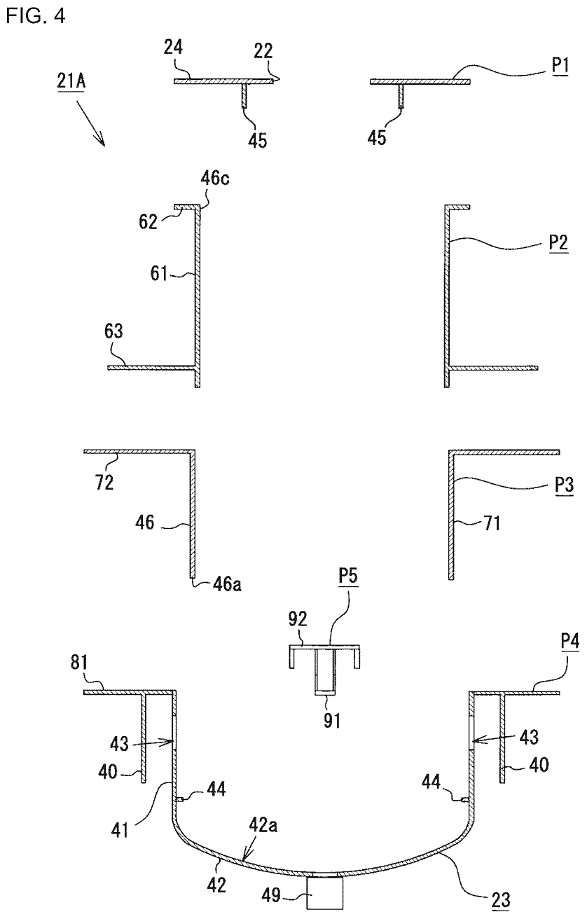

Next, the sealed-type coating-machine cleaning hopper 21A of the second embodiment, which embodies the present invention, will be described in detail with reference to FIGS. 3 and 4. Here, the explanation will focus on the components that differ from the first embodiment, and the common components will be assigned the same reference numbers, with their explanations omitted.

As shown in FIG. 3, the coating-machine cleaning hopper 21A of this embodiment is essentially composed of five detachable parts, P1, P2, P3, P4, and P5, which are assembled together.

The first part P1 includes the upper lid 24 and is located at the top of the coating-machine cleaning hopper 21A. The upper lid 24 has an insertion hole 22, and a restriction wall 45 is formed on the rear side of the upper lid 24, surrounding the insertion hole 22. Additionally, on the rear side of the upper lid 24, a disk-shaped plate 51 is supported, which is positioned parallel to the upper lid 24 with a space in between.

The second part P2 includes the upper cylindrical member 61, which forms part of the cylindrical body 46, and is located below the first part P1. An upper flange section 62 is formed at the upper end of the upper cylindrical member 61, and a lower flange section 63, which extends further outward in the lateral direction than the upper flange section 62, is formed near the lower end.

The third part P3 includes the lower cylindrical member 71, which forms part of the cylindrical body 46, and is located below the second part P2. The lower cylindrical member 71 is a cylindrical component with a diameter nearly equal to that of the upper cylindrical member 61, and it is connected to the lower end of the upper cylindrical member 61. A flange section 72 is formed at the upper end of the lower cylindrical member 71.

The fourth part P4 includes the tank-shaped member 23, which has the outer wall section 41, the bottom section 42, the baffle plate 44, the cover member 40, and the liquid discharge passage 49. It is arranged to surround the third part P3 from the outside. A flange section 81 is formed at the upper end of the tank-shaped member 23, and the cover member 40 is provided on the lower side of this flange section 81.

The fifth part P5 consists of the filter member 91 and the support structure 92 that holds it. The filter member 91 is positioned within the liquid discharge passage 49, which is located at the center of the bottom section 42. The support structure 92 is provided at the center of the inner surface 42a of the bottom section 42, suspending and supporting the filter member 91 below it.

The upper lid 24 of the first part P1 and the upper flange section 62 of the second part P2 are arranged to overlap and are fastened together using bolts and nuts (preferably wing bolts and wing nuts, both not shown). Similarly, the lower flange section 63 of the second part P2, the flange section 72 of the third part P3, and the flange section 81 of the fourth part P4 are arranged to overlap and are fastened together using bolts and nuts (preferably wing bolts and wing nuts, both not shown).

In the coating-machine cleaning hopper 21A of this embodiment, by loosening the bolts and nuts that fasten the upper lid 24 and the upper flange section 62 of the second part P2, the first part P1 and the second part P2 can be easily separated. Similarly, by loosening the bolts and nuts that fasten the lower flange section 63 of the second part P2, the flange section 72 of the third part P3, and the flange section 81 of the fourth part P4, the second, third, and fourth parts P2 to P4 can be easily separated. Furthermore, by pulling the filter member 91 out of the liquid discharge passage 49 while holding the support structure 92, the fifth part P5 can be easily separated from the fourth part P4. In other words, since the components of the coating-machine cleaning hopper 21A can be disassembled into five parts (the first to fifth parts P1 to P5), each component can be cleaned more easily compared to a non-detachable configuration. Therefore, the maintenance efficiency is improved. Additionally, according to this embodiment, since the third and fourth parts P3 and P4 are separable, the baffle plate 44 in the narrow space 47 between the outer wall section 41 and the cylindrical body 46 can be exposed. Thus, it is possible to easily and thoroughly clean the area around the baffle plate 44, which is usually difficult to clean. Additionally, in this embodiment, bolts and nuts are separately provided for fastening the first and second parts P1 and P2 (referred to as the ‘upper fastening screw components’ for convenience) and for fastening the second to fourth parts P2 to P4 (referred to as the ‘lower fastening screw components’ for convenience). Therefore, if it is necessary to clean only the lower area of the coating-machine cleaning hopper 21A, there is no need to fully disassemble the entire unit into parts P1 to P5. It is sufficient to loosen and remove only the lower fastening screw components while leaving the upper fastening screw components as they are. This allows the lower parts P3 to P5, which make up the lower area, to be separated from the upper parts P1 to P2, and only the lower area can be cleaned. As a result, the burden of disassembly and reassembly for cleaning is reduced.

The embodiments of the present invention may be modified as follows.

In the above embodiment, the cover member 40 is provided further outside the outer wall section 41, but the cover member 40 is not an essential component of the present invention and may be omitted if unnecessary.

In the above embodiment, four exhaust holes 43 were formed in the upper region of the outer wall section 41, but the number of exhaust holes 43 can, of course, be changed. Additionally, the exhaust holes 43 may be formed even higher than the position shown in FIG. 2.

In the above embodiment, the lower end 46a of the cylindrical body 46 is positioned below the height of the baffle plate 44, but this is not limiting. For example, the lower end 46a of the cylindrical body 46 may be positioned at the same height as or above the baffle plate 44.

In the above embodiment, a single restriction wall 45 is provided, protruding from the rear opening edge of the insertion hole 22 in the upper lid 24, but it is not limited to this. For example, another restriction wall 45 surrounding the existing one may also be protrudingly provided. In other words, the restriction wall 45 may be formed in a double layer instead of a single layer.

### Description of the Reference Numerals

4: Coating machine
6: Rotating atomizing head
21, 21A: Coating-machine cleaning hopper
22: Insertion hole
23: Tank-shaped member
24: Upper lid
41: Outer wall section
42: Bottom section
42a: Inner surface
43: Exhaust hole
44: Baffle plate
45: Restriction wall
46: Cylindrical body
46a: Lower end of the inner wall section
46c: Opening
48: Gap
61: Upper cylindrical member
62: Upper flange section
63: Lower flange section
71: Lower cylindrical member
72: Flange section
81: Flange section
91: Filter member
t1: Protrusion amount of the restriction wall
t2: Protrusion amount of the inner wall section
P1-P5: First to fifth parts“

1. A coating machine cleaning hopper, comprising:
a cylindrical body having an opening at an upper end and a cleaning space inside; and
an upper lid covering the opening, the upper lid having an insertion hole through which a rotating atomizing head, rotatably provided on the coating machine, can be inserted into the cylindrical body;
wherein a tank-shaped member is provided outside the cylindrical body, the tank-shaped member including a cylindrical outer wall section with exhaust holes formed in an upper portion, and a bottom section with a concavely curved inner surface; and
a baffle plate provided, protruding around the entire circumference of the lower inner surface of the outer wall section, restricting the upward movement of waste paint discharged from the rotating atomizing head.

2. A coating-machine cleaning hopper according to claim 1, wherein a restriction wall is provided protruding from the rear opening edge of the insertion hole in the upper lid, extending toward the bottom, to restrict the flow of waste paint from the cylindrical body side toward the insertion hole side.

3. The coating-machine cleaning hopper according to claim 2, wherein the lower end of the cylindrical body is positioned below the height of the baffle plate, and a gap is provided between the cylindrical body and the baffle plate.

4. The coating-machine cleaning hopper according to claim 2, wherein the amount of downward protrusion of the restriction wall, based on the rear surface of the upper lid, is smaller than the amount of downward protrusion of the cylindrical body, based on the rear surface of the upper lid.

5. The coating-machine cleaning hopper according to claim 1, comprising a first part including the upper lid, a second part including the upper cylindrical member forming the cylindrical body, a third part including the lower cylindrical member connected to the lower end of the upper cylindrical member and forming part of the cylindrical body, and a fourth part including the tank-shaped member that has the outer wall section, the bottom section, and the baffle plate, with each of these parts being able to be disassembled and assembled together.

6. The coating-machine cleaning hopper according to claim 5, further comprising a fifth part including a filter member disposed in the liquid discharge passage provided at the central part of the bottom, with each of these parts being able to be disassembled and assembled together.

7. The coating-machine cleaning hopper according to claim 6, wherein the upper lid of the first part and the upper flange of the second part are arranged overlapping each other and fastened together with screws, and the lower flange of the second part, the flange of the third part, and the flange of the fourth part are arranged overlapping each other and fastened together with screws.
